(19) United States
(12) Patent Application Publication
(10) Pub. No.: US 2015/0116215 A1
(43) Pub. Date: Apr. 30, 2015

(54) REMOTE CONTROLLER AND METHOD THEREOF

(71) Applicant: Much-ip Co., Ltd., Hsinchu County (TW)

(72) Inventors: Shoa-Hung LO, Hsinchu County (TW); Ming-Chou LEE, Hsinchu County (TW)

(21) Appl. No.: 14/517,059

(22) Filed: Oct. 17, 2014

(30) Foreign Application Priority Data
Oct. 31, 2013 (TW) 102139451

(51) Int. Cl. G06F 3/033; G06F 3/041; G06F 3/0485

(52) U.S. Cl. CPC G06F 3/033; G06F 3/0485; G06F 3/041
USPC 345/157; 345/156; 345/173

(57) ABSTRACT

The present invention provides a remote controller for wirelessly controlling an electronic apparatus. The remote controller comprises: a wireless interface configured to wirelessly connect to the electronic apparatus; a user input interface configured to receive a single input command from the user; and a processing module. The processing module is configured to send multiple control messages via the wireless interface to the electronic apparatus according to the single input command received via the user input interface such that the electronic apparatus performs display operations corresponding to the multiple control messages shown on a display module.

### CROSS REFERENCE TO RELATED APPLICATIONS

This application claims priority to Taiwanese patent application, No. 102139451, filed on Oct. 31, 2013, entitled “REMOTE CONTROL DEVICE, SYSTEM AND METHOD THEREOF”, which is hereby incorporated by reference in its entirety.

### BACKGROUND OF THE INVENTION

1. Field of the Invention

The present invention relates to a remote controller, and more particularly, to a remote controller for receiving a single input command and performing complex remote control operations.

2. Description of the Prior Art

People use remote controllers at least several times a day. Many electronics, such as televisions, optical disc players, set-top boxes, air conditioners, etc. are equipped with a corresponding remote controller for convenience. However, the functions of these electronics are relatively simple, and each button on the remote controller corresponds to a single function.

For example, on a TV remote controller, one button serves as a power switch. Two buttons are required to adjust the volume. Another button is needed to switch between different signal sources. When a user wants to watch a DVD, he must first pick up the TV remote controller and press the power switch button, then the signal source button to select input from the DVD player, and then the volume buttons. In other words, each time the user wants to watch a DVD, he needs to press a series of multiple buttons.

Following the rapid spread of smart electronic apparatus, increasingly more electronic apparatus are equipped with monitors and processing modules capable of executing any program. For example, smart set-top boxes or smart TV open operating systems and third party programs can be executed on these electronic apparatus. The human machine interface of these operating systems may include a traditional keyboard and mouse to direct user input to the corresponding input focus and cursor. Some operating systems include a touch sensitive human machine interface and are modified accordingly to optimize user experience. However, it is very difficult, if not impossible, to command such electronic apparatus to perform routine operations such as scrolling pages, sliding windows, etc. via a traditional remote controller with a single input command.

Hence, there exists a need for a programmable remote controller that allows the user to command the corresponding electronic apparatus to perform the corresponding display operations with a single input command.

As can be seen from the above, it is clear that prior art still has various shortcomings. Many unsuccessful attempts have been made in order to solve these problems, and ordinary products and methods have failed to provide an appropriate solution Thus, there is a need in the industry for a novel device that solves these problems.

### SUMMARY OF THE INVENTION

In one embodiment of the present invention, a remote control system is provided. The remote control system comprises a display module, an electronic apparatus paired with the display module, and a remote controller configured to wirelessly control the electronic apparatus. The remote controller comprises: a wireless interface configured to wirelessly connect to the electronic apparatus; a user input interface configured to receive a single input command from the user; and a processing module. The processing module is configured to send multiple control messages via the wireless interface to the electronic apparatus according to the single input command received via the user input interface such that the electronic apparatus performs display operations corresponding to the multiple control messages shown on a display module.

In another embodiment of the present invention, a remote controller for wirelessly controlling an electronic apparatus is provided. The remote controller comprises: a wireless interface configured to wirelessly connect to the electronic apparatus; a user input interface configured to receive a single input command from the user; and a processing module. The processing module is configured to send multiple control messages via the wireless interface to the electronic apparatus according to the single input command received via the user input interface such that the electronic apparatus performs display operations corresponding to the multiple control messages shown on a display module.

In an alternative embodiment of the present invention, a remote controlling method applicable to a processing module of a remote controller is provided. The remote controlling method comprises: receiving a single input command from the user via a user input interface of the remote controller; and sending multiple control messages to the electronic apparatus via a wireless interface of the remote controller according to the single input command received via the user input interface such that the electronic apparatus performs display operations corresponding to the multiple control messages shown on a display module.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 depicts a schematic block diagram of a remote control system in accordance with an embodiment of the present invention.

FIG. 2 illustrates a mapping table between single input commands and multiple control commands according to an embodiment of the present invention.

FIG. 3 shows a diagram of multiple touch sensitive areas of a touch sensitive device in accordance with an embodiment of the present invention.

FIG. 4 depicts a flowchart diagram of a remote controlling method according to an embodiment of the present invention.

### DETAILED DESCRIPTION OF THE PREFERRED EMBODIMENTS

Some embodiments of the present invention are described in detail below. However, in addition to the descriptions given below, the present invention can be applied to other embodiments, and the scope of the present invention is not limited by such specifics, but rather by the scope of the claims. Moreover, for better understanding and clarity of description, some components in the drawings may not necessarily be drawn to scale, as which some may be exaggerated relative to others and irrelevant parts may be omitted.

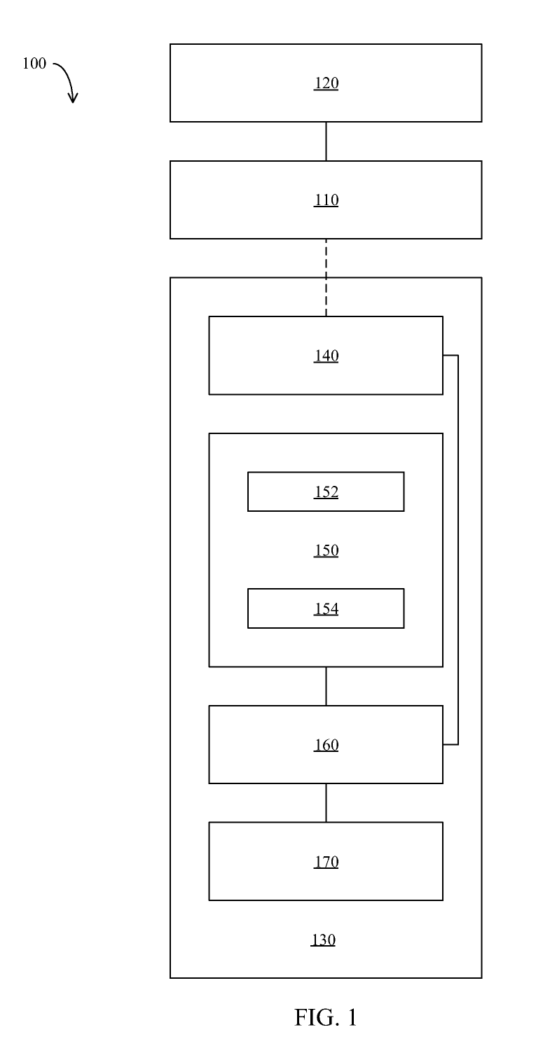

Please refer to FIG. 1, which depicts a schematic block diagram of a remote control system 100 in accordance with an embodiment of the present invention. The remote control system 100 comprises at least one electronic apparatus 110 to be remote-controlled and a remote controller 130. The electronic apparatus 110 connects to a display module 120 which is configured to display the content output of the electronic apparatus 110. In some embodiments, the electronic apparatus 110 comprises a display module 120, e.g., when the electronic apparatus 110 is a smart TV or an all-in-one computer. In other embodiments, the electronic apparatus 100 does not comprise the display module 120, e.g., when the electronic apparatus 110 is a set-top box and the display module 120 is a television connected to the set-top box.

In the embodiment shown in FIG. 1, the electronic apparatus 110 executes an operating system which can display an operating environment via the display module 120. The operating environment may comprise a windows operating environment, wherein exists a virtual desktop. The visible area of the virtual desktop is equivalent to the display capability of the display module 120. For example, if the display resolution of the display module 120 is set as 1920×1200, the visible area of the desktop is 1920×1200. The total area of the virtual desktop is larger than the display capability of the display module 120. In some instances, the area of the virtual desktop is a multiple of the visible area of the desktop, such as 3840×1200 or 5760×2400.

If the area of the virtual desktop is larger than the display capability of the display module 120, the user can rearrange the visible area of the virtual desktop by commanding the electronic apparatus 110 to scroll or swipe through pages. The user can scroll or swipe through the visible area of the virtual desktop in several ways. When using a mouse, the user can press a button on the mouse to “fix” the cursor on a single point on the virtual desktop, then move the mouse in one direction and release the button, thereby scrolling the virtual desktop along the direction in which the mouse moves. The scrolling distance is determined by the distance the mouse moves and/or the moving speed of the mouse.

In some operating systems or windows operating environments, the virtual desktop is paged. For example, the coordinates of the lower right corner of the first page are (1919, 1119) and the coordinates of the lower right corner of the second page are (3839, 2399). The visible area of each page is equivalent to the display capability of the display module 120. However, only one page of the virtual desktop is shown at a time. Generally, a user swipes through the pages of the virtual desktop in a similar manner. However, the entire page, rather than a portion, of the virtual desktop is replaced by a new page.

For an electronic apparatus 110 equipped with a touch sensitive input interface, the act of pressing a mouse button could be substituted by using a single finger to touch said input interface. One with ordinary skill in the art would understand that the act of a user placing their finger on a particular point on the touch sensitive input interface would be equivalent to moving a cursor to a particular point on a virtual desktop and pressing the mouse button. In the same way, the act of a user moving their finger to another point on the touch sensitive input interface and then releasing would be equivalent to moving the cursor to another point on a virtual desktop and then releasing the mouse button.

In the embodiment shown in FIG. 1, the remote controller 130 comprises a wireless interface 140, an input interface 150, a processing module 160, and a memory module 170. The wireless interface 140 connects to the processing module 160 and is configured to connect wirelessly to the electronic apparatus 110. There are several ways to set up a wireless connection. In one embodiment, the wireless interface 140 comprises an infra-red remote control module which is configured to transmit traditional infra-red code to the electronic apparatus 110. In another embodiment, the wireless interface 140 comprises a Bluetooth module which is configured to be paired with the electronic apparatus 110 using Bluetooth wireless communications protocol. One with ordinary skill in the art would understand that the present invention does not limit the wireless technologies adopted by the wireless interface 140 for connecting to the electronic apparatus 110. The present invention does not limit whether the wireless interface 140 is capable of pertain connection status and acknowledgement transmission, as long as the processing module 160 can transmit multiple command messages to the electronic apparatus 110 via the wireless interface 140.

The aforementioned input interface 150 may comprise at least one button 152 and a touch sensitive device 154. In one embodiment, when the button 152 is pressed it sends a single input command to the processing module 160. In other embodiments, the single input command sent by the button 152 may prompt the electronic apparatus 110 to execute some display operations. The display operations may include, but are not limited to, at least one of the following: moving the cursor on the display module 120; scrolling the content shown on the display module 120; and swiping to another page shown on the display module 120.

In another embodiment, in response to detecting an external object approaching or touching the touch sensitive device 154, a single input command is sent to the processing module 160. In some embodiments, the touch sensitive device 154 may comprise multiple touch sensitive areas, with each one corresponding to a different single input command. For example, the touch sensitive device 154 comprises a first touch sensitive area and a second touch sensitive area. The display operation of a first single input command received via the first touch sensitive area would be different from the display operation of a second signal input command received via the second touch sensitive area. For example, an external object approaching or touching the first touch sensitive area would prompt a display operation equivalent to pressing on a cursor; whereas an external object approaching or touching the second touch sensitive area would prompt another display operation equivalent to moving a cursor.

After receiving a single input command from the input interface 150, the processing module 160 can retrieve the corresponding multiple control messages stored in the memory module 170 and send said multiple control messages to the electronic apparatus 110 via the wireless interface 140, prompting the electronic apparatus 110 to perform display operations corresponding to the received multiple control messages.

The memory module 170 internally stores multiple control messages corresponding to at least one single input command. The memory module 170 may contain read-only memory or re-writable memory. When the memory module is re-writable, the single input command and the corresponding multiple control messages are programmable. In other words, the single input command and the corresponding multiple control messages stored in the memory module 170 may be added, deleted, and modified. In one embodiment, the processing module 160 and the memory module 170 are implemented in different chips. In another embodiment, the processing module 160 and the memory module 170 are implemented in the same chip. The present invention does not limit the implementations.

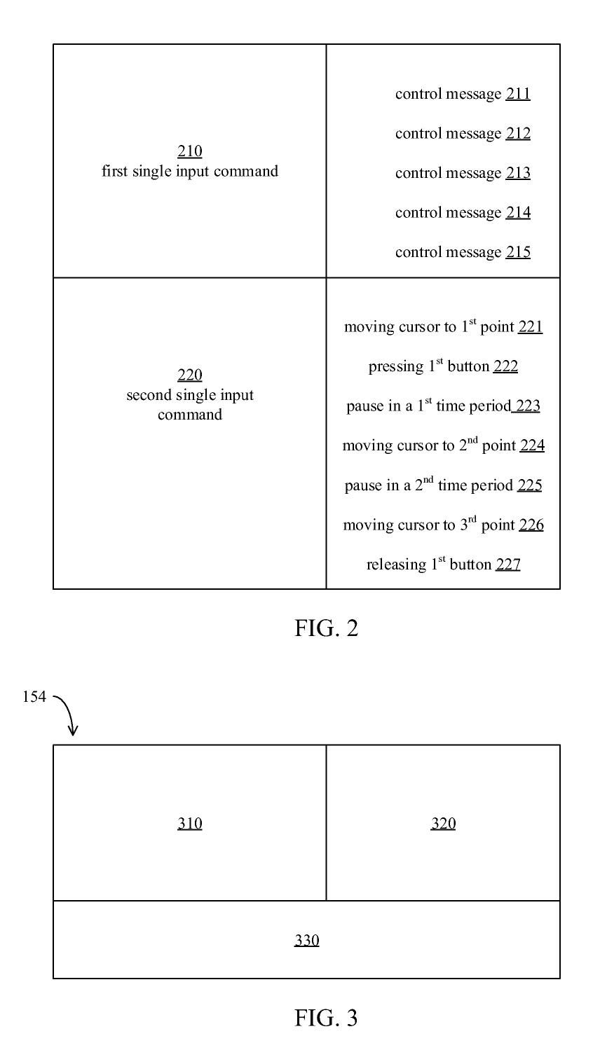

Please refer to FIG. 2, which illustrates a mapping table between single input commands and multiple control commands according to an embodiment of the present invention. Two single input commands 210 and 220 are shown in FIG. 2. A first single input command 210 corresponds to multiple control messages 211 to 215. A second single input command 220 corresponds to multiple control messages 211 and multiple internal instructions.

Suppose that the second single input command is configured to change the page of the virtual desktop of the electronic apparatus 110. The corresponding first control message 221 is configured to move the cursor to a first point. Next, the second control message 222 is configured to press a first button on the cursor which has already moved to the first point. The first button functions as the left button of a mouse. After the two control messages 221 and 222 are sent, some time is needed for the electronic apparatus 110 to process these two control messages. Hence, an internal instruction 223 follows which prompts the processing module 160 to pause operation in a first time period. The internal instruction 223 differs from the previous two control messages 221 and 222 in that the remote controller 130 does not send the internal instruction 223 to the electronic apparatus 110. The internal instruction 223 is only executed within the processing module 160. The rest of the control commands that correspond to the second single input command are control message 224, an internal instruction 225, and control messages 226 and 227.

In some embodiments, the user can update the content of the memory module 170 via the processing module 160. In another embodiment, when the remote controller 130 is configured to remote-control more than one electronic apparatus 110, the embodiment shown in FIG. 2 can further comprise codes corresponding to the electronics apparatus 110 to be controlled. For example, when used to control a first electronic apparatus, the second single input command corresponds to a first set of control messages and internal instructions. When used to control a second electronic apparatus, the same second single input command corresponds to a second set of control messages and internal instructions.

Please refer to FIG. 3, which shows a diagram of multiple touch sensitive areas of a touch sensitive device in accordance with an embodiment of the present invention. The touch sensitive device 154 may take the form of the touch sensitive device shown in FIG. 1, and may be divided into multiple touch sensitive areas such as a first touch sensitive area 310, a second touch sensitive area 320, and a third touch sensitive area 330 as shown in FIG. 3. When the user presses the first touch sensitive area 310 and the second touch sensitive area 320, different single input commands are triggered and the electronic apparatus 110 performs different display operations.

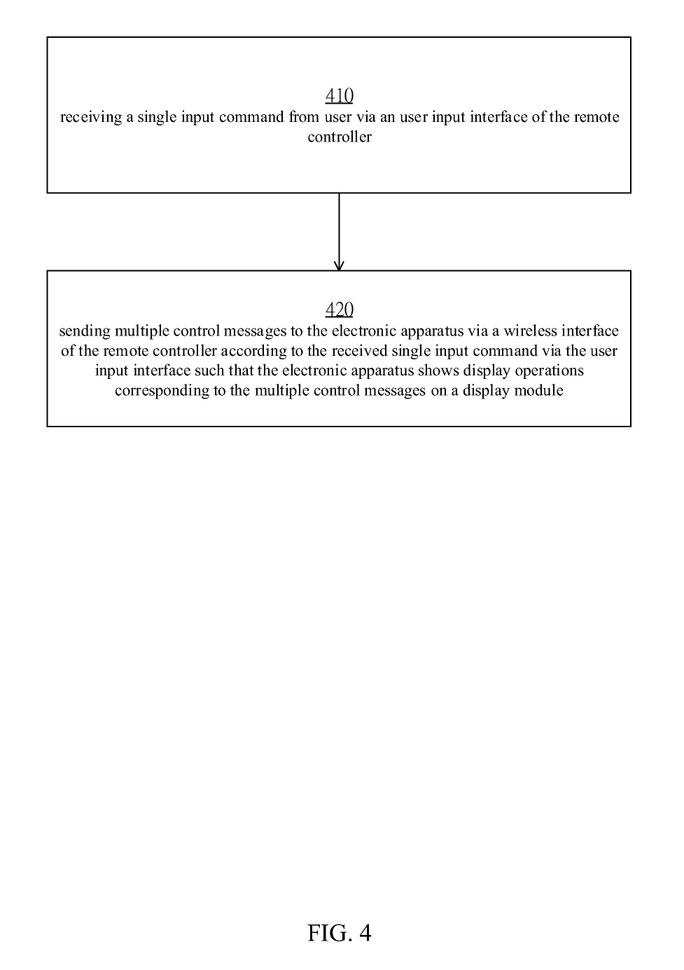

Please refer to FIG. 4, which depicts a flowchart diagram of a remote controlling method according to an embodiment of the present invention. The remote controlling method is applicable to a processing module of a remote controller. The descriptions related to FIGS. 1 to 3 may be used as references for understanding the description of the remote controlling method shown in FIG. 4 which comprises at least the following steps:

Step 410: receiving a single input command from the user via a user input interface of the remote controller.

Step 420: sending multiple control messages to the electronic apparatus via a wireless interface of the remote controller according to the single input command received via the user input interface such that the electronic apparatus performs display operations corresponding to the multiple control messages shown on a display module.

One with ordinary skill in the art would understand that the following description with respect to the remote controlling method can apply to the embodiments related to FIGS. 1 to 3.

The display operations corresponding to the single input command comprise at least one of the following: moving the cursor on the display module; scrolling the content shown on the display module; and swiping through pages shown on the display module.

The control message comprises at least one or any combination of the following information: coordinate information corresponding to the display module; and control information corresponding to the coordinate information.

The remote controlling method further comprises storing the single input command and the corresponding multiple control messages in a memory module of the remote controller. The single input command and the multiple control messages stored in the memory module are programmable. The remote controlling method further comprises storing at least one internal instruction between the multiple control messages in the memory module; and executing the at least one internal instruction without sending a control message to the electronic apparatus via the wireless interface.

The user input interface comprises at least one or any combination of the following: a button; and a touch sensitive device. The touch sensitive device comprises a first touch sensitive area and a second touch sensitive area. The display operations corresponding to a first single input command received via the first touch sensitive area are different from the display operations corresponding to a second single input command received via the second touch sensitive area.

In one embodiment, the wireless interface transmits the multiple control messages to the electronic apparatus unilaterally. In another embodiment, the wireless interface is configured to wirelessly receive at least one acknowledgement message sent from the electronic apparatus. The acknowledgement message corresponds to one of the multiple control messages.

The above embodiments are only used to illustrate the principles of the present invention, and they should not be construed to limit the present invention in any way. The above embodiments may be modified by those with ordinary skill in the art without departing from the scope of the present invention as defined in the following appended claims.

What is claimed is:

1. A remote controller for wirelessly controlling an electronic apparatus, comprising:
a wireless interface configured to wirelessly connect to the electronic apparatus;
a user input interface configured to receive a single input command from a user; and
a processing module configured to send multiple control messages via the wireless interface to the electronic apparatus according to the single input command received via the user input interface such that the electronic apparatus performs display operations corresponding to the multiple control messages shown on a display module.

2. The remote controller of claim 1, wherein the display operations corresponding to the multiple control messages comprises at least one of the following:
moving a cursor on the display module;
scrolling the content shown on the display module; and
swiping through pages shown on the display module.

3. The remote controller of claim 1, wherein the control message comprises at least one or any combination of the following information:
coordinate information corresponding to the display module; and
control information corresponding to the coordinate information.

4. The remote controller of claim 1, further comprising a memory module configured to store the single input command and the corresponding multiple control messages.

5. The remote controller of claim 4, wherein the single input command and the corresponding multiple control messages stored in the memory module are programmable.

6. The remote controller of claim 4, wherein the memory module is further configured to store at least one internal instruction between the multiple control messages, and the processing module is further configured to execute the at least one internal instruction without sending a control message to the electronic apparatus via the wireless interface.

7. The remote controller of claim 1, wherein the user input interface comprises at least one or any combination of the following:
a button; and
a touch sensitive device.

8. The remote controller of claim 7, wherein the touch sensitive device comprises a first touch sensitive area and a second touch sensitive area, the display operations corresponding to a first single input command received via the first touch sensitive area are different from the display operations corresponding to a second single input command received via the second touch sensitive area.

9. The remote controller of claim 1, wherein the wireless interface transmits the multiple control messages to the electronic apparatus unilaterally.

10. The remote controller of claim 9, wherein the wireless interface is further configured to receive at least one acknowledgement message sent from the electronic apparatus, and the at least one acknowledgement message corresponds to one of the multiple control messages.

11. A remote controlling method applicable to a processing module of a remote controller, comprising:
receiving a single input command from a user via a user input interface of the remote controller; and
sending multiple control messages to the electronic apparatus via a wireless interface of the remote controller according to the single input command received via the user input interface such that the electronic apparatus performs display operations corresponding to the multiple control messages shown on a display module.

12. The remote controlling method of claim 11, wherein the display operations corresponding to the multiple control messages comprises at least one of the following:
moving a cursor on the display module;
scrolling the content shown on the display module; and
swiping through pages shown on the display module.

13. The remote controlling method of claim 11, wherein the control message comprises at least one or any combination of the following information:
coordinate information corresponding to the display module; and
control information corresponding to the coordinate information.

14. The remote controlling method of claim 11, further comprising:
storing the single input command and the corresponding multiple control messages in a memory module.

15. The remote controlling method of claim 14, wherein the single input command and the corresponding multiple control messages stored in the memory module are programmable.

16. The remote controlling method of claim 14, further comprising:
storing at least one internal instruction between the multiple control messages; and
executing the at least one internal instruction without sending a control message to the electronic apparatus via the wireless interface.

17. The remote controlling method of claim 11, wherein the user input interface comprises at least one or any combination of the following:
a button; and
a touch sensitive device.

18. The remote controlling method of claim 17, wherein the touch sensitive device comprises a first touch sensitive area and a second touch sensitive area, and the display operations corresponding to a first single input command received via the first touch sensitive area are different from the display operations corresponding to a second single input command received via the second touch sensitive area.

19. The remote controlling method of claim 11, wherein the wireless interface transmits the multiple control messages to the electronic apparatus unilaterally.

20. The remote controlling method of claim 19, wherein the wireless interface is further configured to receive at least one acknowledgement message sent from the electronic apparatus, and the at least one acknowledgement message corresponds to one of the multiple control messages.
